(19) United States
(12) Patent Application Publication
(10) Pub. No.: US 2006/0089841 A1
(43) Pub. Date: Apr. 27, 2006

(54) Method of gift giving utilizing a reusable gift container

(76) Inventor: Teryl L. McKnight, St. George, UT (US)

Correspondence Address: Brent T. Winder;Jones Waldo Holbrook & McDonough, Suite 1500, 170 South Main Street, Salt Lake City, UT, 84101-1644, US

(21) Appl. No.: 10/971,464

(22) Filed: Oct. 22, 2004

(51) Int. Cl. G06Q 99/00

(52) U.S. Cl. 705/1

(57) ABSTRACT

A method of gift giving, utilizing a reusable gift container, whereby a gift container history is generated including one or more items of past user personal information. The gift container has at least one unique physical feature; a container history document; and an identifier, whereby the gift container can be distinguished from other gift containers. As the gift container is passed to succeeding users, information regarding the container and its respective users can be entered into a searchable online database by a database manager. These steps can be repeated, optionally, until retirement of the gift container is desired by a final user, who then notifies the database manager that the gift container is to be retired by providing one or more items of retirement information. The database manager is then directed to retire the gift container.

### BACKGROUND

In today's world, gifts are exchanged on numerous occasions. Birthdays, weddings, anniversaries, Christmas, and a host of other events cause people to reach deep into their hearts, and their bank accounts, to present loved-ones with thoughtful gifts that, it is hoped, will bring some measure of happiness into their lives.

However, with an ever-increasing emphasis on commercialism and materialism in connection with gift-giving occasions, as well as an increase in the number of actual occasions for which gifts are given, much of the joy found in both giving and receiving gifts is lost.

The present invention alleviates this problem, as well as others not specifically mentioned, by providing a fun, long-lasting, and rewarding way for delivering gifts that places the emphasis on the gift-giving process, rather than the material value of the gift itself.

### SUMMARY

The present invention is a method of gift giving, utilizing a reusable gift container, whereby a gift container history is generated including one or more items of past user personal information. The method comprises the steps of providing the reusable gift container to a first user, the gift container having at least one unique physical feature; a container history document; and an identifier, whereby the gift container can be distinguished from other gift containers. The identifier is entered into a searchable online database through an identifier input interface. The first user is then directed to update the container history document by providing the identifier and one or more items of personal information to a database manager. The one or more items of personal information can include, but are not limited to, a user nickname, geographical information, a user message, the gift container purchase date, the gift container name, and a gift description. The database manager is then directed to input the one or more items of first user personal information into the searchable online database according to the identifier, and to provide the first user with the container history document including the one or more items of first user personal information.

The first user is then directed to convey the gift container, the container history document, and a first gift, to a second user. The second user is then directed to update the container history document by providing the identifier and one or more items of personal information to the database manager, including, but not limited to, a nickname, geographical information, a message and a gift description. The database manager is then directed to input the second user's personal information into the searchable online database according to the identifier, and to provide the second user with the container history document including the first and second users' personal information.

The second user can then, optionally, be directed to convey the gift container, the container history document, and a second gift, to a third user. This third user is then directed to update the container history document by providing the identifier and one or more items of third user personal information to the database manager, the one or more items of third user personal information including, but not limited to, a nickname, geographical information, a message, and a gift description. The database manager can then be directed to input the one or more items of third user personal information into the searchable online database according to the identifier, and to provide the third user with the container history document including the one or more items of first, second and third user personal information. The third user can then, optionally, be directed to convey the gift container, the container history document, and a third gift, to a fourth user. These steps can be repeated, optionally, until retirement of the gift container is desired by a final user. The final user then notifies the database manager that the gift container is to be retired by providing one or more items of retirement information, including, but not limited to, a notice of retirement, a gift container retirement date, and a retirement message. The database manager is then directed to retire the gift container. Thus, the container history document, as updated by the first user through the final user, provides a gift container history including one or more items of past user personal information.

In one embodiment, the first user updates the container history document with one or more items of user personal information, the one or more items of user personal information including, but not limited to, a user nickname, a user geographical indicator, a user message, a gift container purchase date, a gift container name, and a user gift description. The first user is then directed to convey the gift container, the container history document, and a first gift, to a second user, who then is directed to update the container history document with one or more items of user personal information. The second user is then directed to convey the gift container, the container history document, and a second gift, to a third user. These steps are, optionally, repeated until retirement of the gift container is desired by a final user. In this embodiment, one or more of the users provide the identifier and the one or more items of personal information to a database manager, who then inputs the information into the online searchable database through a personal information input interface.

### BRIEF DESCRIPTION OF THE DRAWINGS

FIG. 1 shows an example of a reusable gift container according to one embodiment of the present invention.

FIG. 2 shows a container history launch form according to one embodiment of the present invention.

FIG. 3 shows an information input interface according to one embodiment of the present invention.

FIG. 4 shows an updated version of the container history form of FIG. 2.

FIG. 5 shows a further updated version of the container history form of FIG. 4.

FIG. 6 shows a final container history document according to one embodiment of the present invention.

FIG. 7 shows a final container history document according to yet another embodiment of the present invention.

FIG. 8 shows a container history form according to yet another embodiment of the present invention.

### DETAILED DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. These drawings depict only typical embodiments of the invention and are not therefore to be considered to be limiting of its scope.

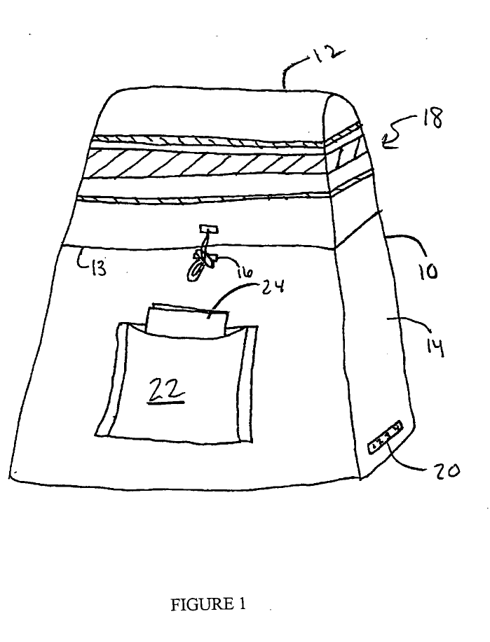

In FIG. 1, is shown an example of a reusable gift container 10 according to one embodiment of the present invention. The gift container 10 includes a top portion 12 and a bottom portion 14 hingedly connected, and that can be closed to form a seam 13. The container 10 can be secured in the closed position by a closing mechanism 16.

It is noted that the exact mechanical make-up of the reusable gift container 10 is not as important as those features that serve to either identify or distinguish the container 10. For example, as seen in FIG. 1, the container 10 includes a unique physical attribute or feature 18, which in this case is a series of decorative stripes on the top portion 12. It is noted that the unique physical attribute 18 could really be any feature, shape, size, color, design, etc. or combination thereof, that would serve to make the containers 10 substantially unique in that they differ from each other.

The container of FIG. 1 also includes an identifier 20, which, in this case, is a serial number 20. The container 10 also includes a receptacle 22 that can be used to hold a container history document or form 24.

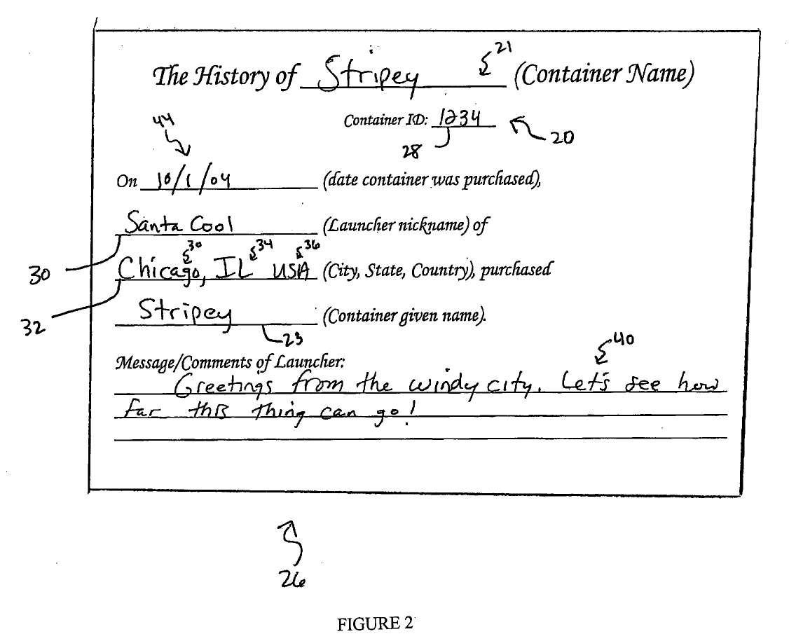

In FIG. 2, is shown an example of a container history information form 26 according to one embodiment of the present invention. This container information form 26 can be provided to a first user, or launcher, of the gift container 10, and is a means whereby the first user can enter various pieces of personal information. For example, this form 26 includes a space 28 where the first user can provide the container identifier 20, as well as spaces 21, 23 where the launcher can assign the container a name. There is also a space 30 where the launcher can enter his or her nickname. There are also spaces 32 for user geographical indicators, such as the launcher's city 30, state 34, and country 36. The form 26 also provides spaces 40, 44 wherein the launcher can enter a message, or other comments, as well as the date on which the container was purchased.

Once this information is furnished, the form 26 can then be submitted to a third party for entry into an online, searchable database. In other embodiments, the form 26 can simply be inserted into the receptacle 22, to be submitted for entry into the database at a future time.

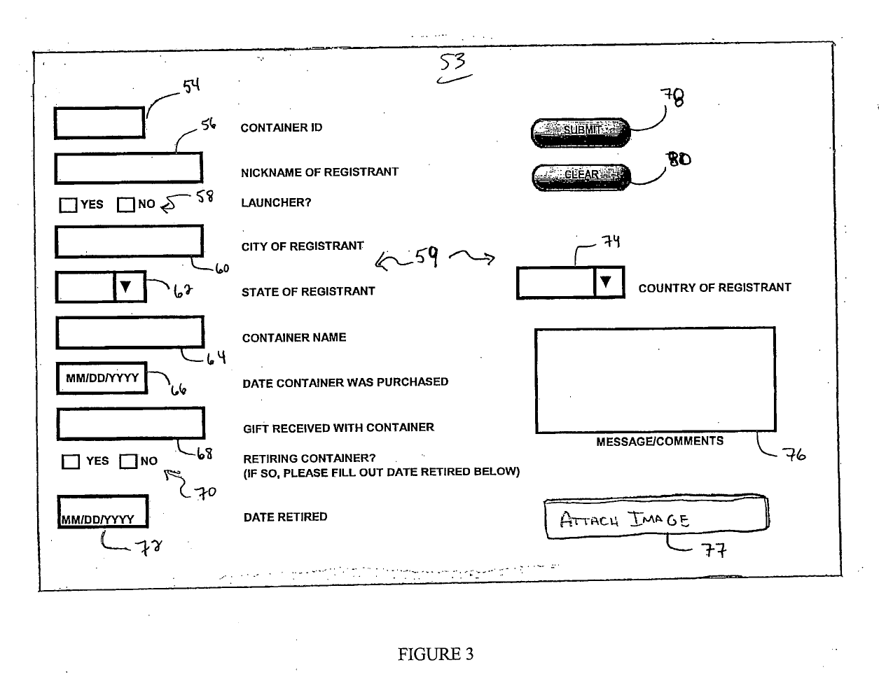

FIG. 3 shows an information input interface 53 according to one embodiment of the present invention. The interface 53 permits a party, in this embodiment a database manager, to enter user information into the online, searchable database. Because the database is available online, it can be searched by past and present users, according to user information (both past and present), as well as the container identifier 20.

The interface 53 includes input boxes that correspond to the information spaces found on the form 26 depicted in FIG. 2. For example, there is a text box 54 wherein the database manager can input the container identifier 20. There are also boxes corresponding to the user nickname 56; geographical indicators of the user 59, such as city 60, state 62, and country 74. Window 66 allows the database manager to input the date the container was purchased; window 68 allows entry of the gift description provided by the user (as will be discussed further below). Other windows 76 allow the database manager to input the message/comments provided by the user, while yet other windows 64 allow input of the container name. The interface 53 also provides for entry of launcher and retirement questions 58, 70 (as will also be discussed further below), and, if the container 10 is, in fact, being retired, a window 72 is included to enter the retirement date.

Another feature of the data input interface 53 is that it permits the database manager to include an image of the container 10 in the database. In this embodiment, the image is attached according to well-known image attaching techniques, by the database manager clicking on button 77. Thus, when a user is searching the database, he or she can, in addition to viewing the user information and container history, view an image of the container itself.

Once the desired information has been entered into the appropriate boxes, and the appropriate questions answered, the database manager can click on the submit button 78, which will then upload the information into the common database. If desired, the database manager can also clear the window contents by clicking the clear button 80.

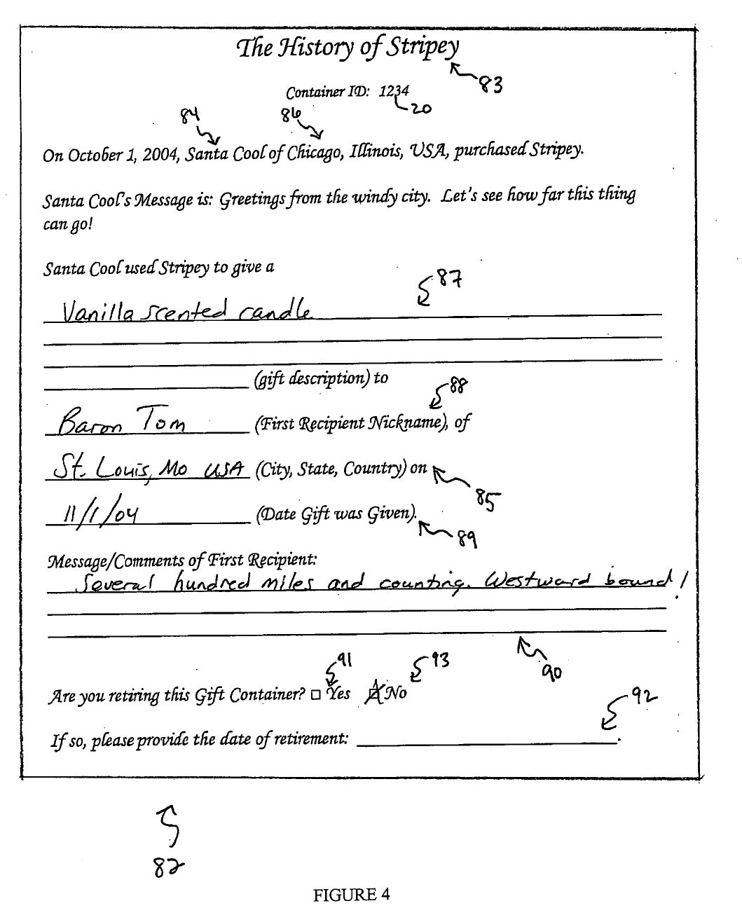

Once the launcher information is entered into the database, an updated container history information form 82 can be generated, as is depicted in FIG. 4. The updated form 82 is generated to include the launcher information, as was entered previously (e.g. the container name 83, the container identifier 20, launcher name 84, and launcher geographical indicators 86).

The updated form 82 also includes new spaces for the second user, or first recipient, to enter various pieces of personal information. For example, there are spaces for the first recipient's geographical information 85, a description of the gift given to the first recipient 87, the gift recipient's desired nickname 88, and the date on which the first recipient received the gift 89. The updated form 82 also provides a space 90 for the first recipient to give comments or a message.

If the first recipient desires to retire the gift container 10, he or she can so indicate by checking the “Yes” box 91. In the present Figure, the “No” box 93 has been checked, indicating that retirement of the container 10 is not yet desired. If retirement is indicated, then the first recipient can also provide the retirement date in the space provided 92.

Once all the appropriate information has been included in form 82, it can then be sent to a database manager, as was the case with FIG. 2, who can then enter the first recipient's information into the database through the information input interface 53 (FIG. 3).

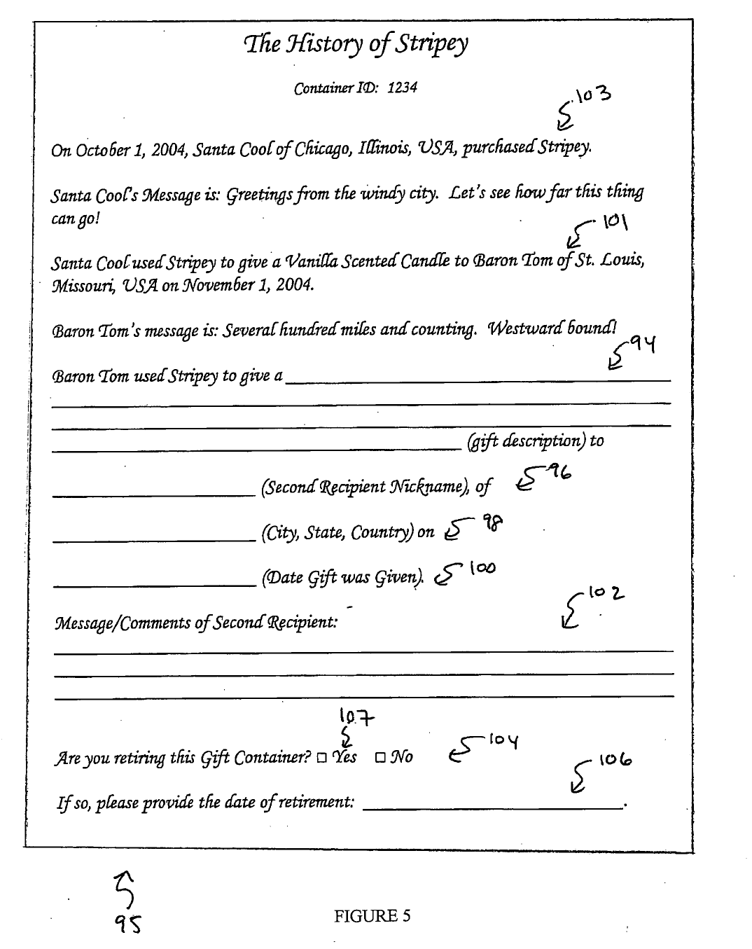

FIG. 5 shows the updated form 95, now including the information provided by the first recipient, as well as spaces for the second recipient to provide the same sort of personal information—e.g. a description of the gift given to the second recipient 94, the second recipient's nickname 96, second recipient's geographical indicators 98, the date on which the gift was given to the second recipient 100, and comments from the second recipient 102. As with FIG. 4, the updated form 95 also includes questions regarding retirement of the container 104, as well as a space for providing the retirement date 106, in the event that retirement is desired.

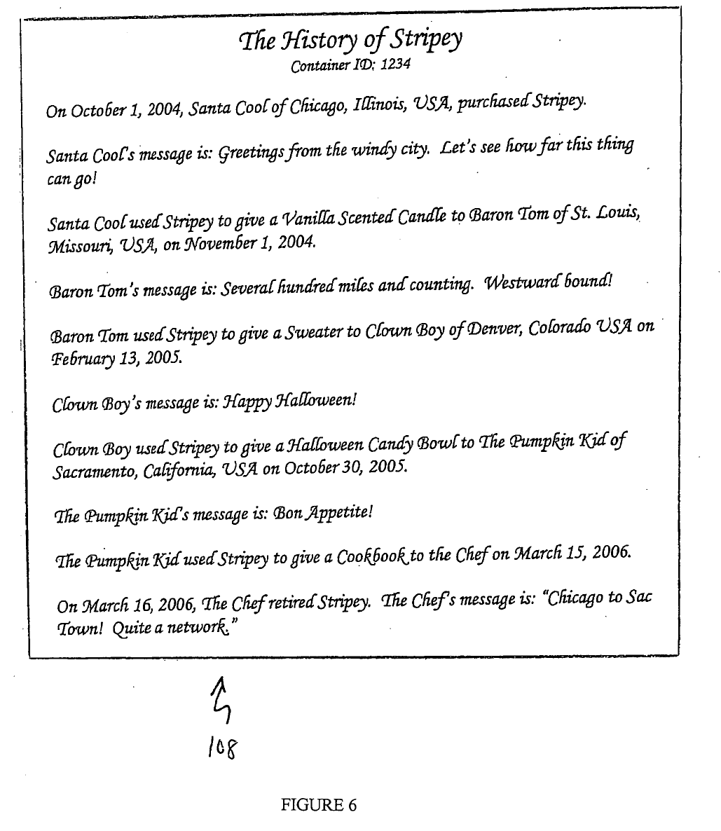

Once the information is filled-out in form 95, it can again be submitted to a database manager for entry into the online, searchable database. Again, an updated form is provided to the subsequent user. This process can be repeated until a recipient decides to retire the container, at which point he or she would check the “Yes” box 107, and would provide the date of retirement in space 106. The final recipient would then submit this information, along with a gift description, nickname, geographical information, the date on which the final gift was given, as well as any final comments/messages, to the database manager. The database manager could then input the information into the database, and generate a final history 108, as is shown in FIG. 6.

In one embodiment, the final history 108, along with the image of the container 10, could then be viewed by all past users through the online searchable database. Alternatively, a final history 108 could be sent to all past users, provided such information has been previously provided.

As will be appreciated, the extent of information contained in the final history depends on 1) the level of information provided by the user; and 2) the total number of users, or recipients.

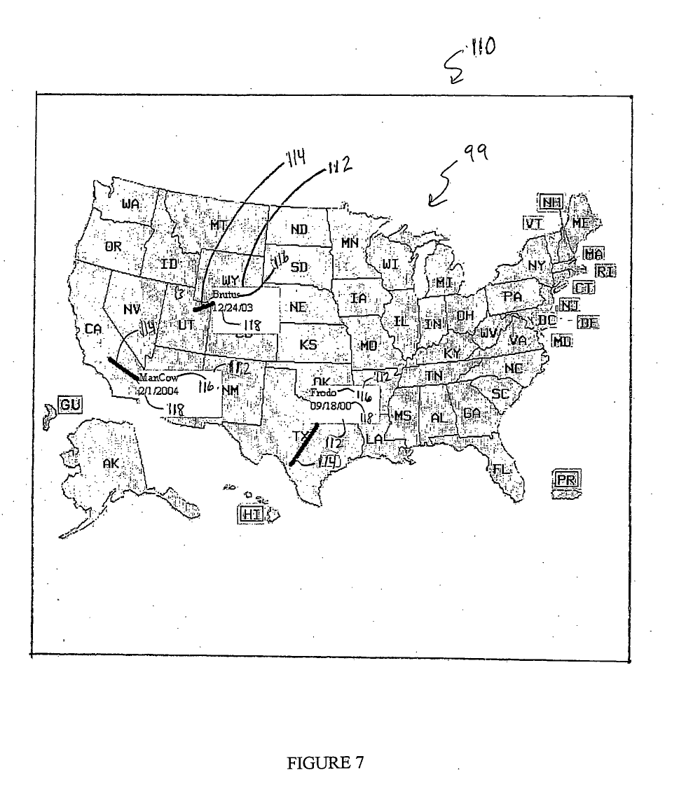

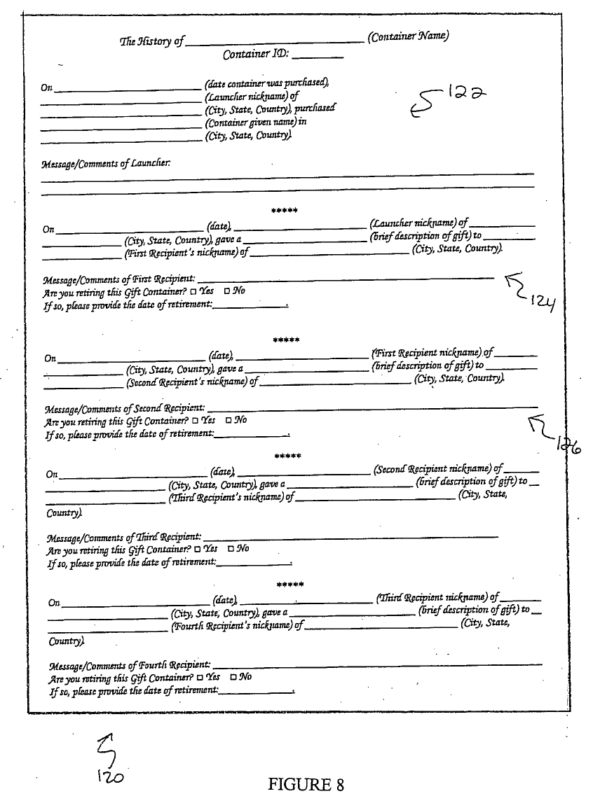

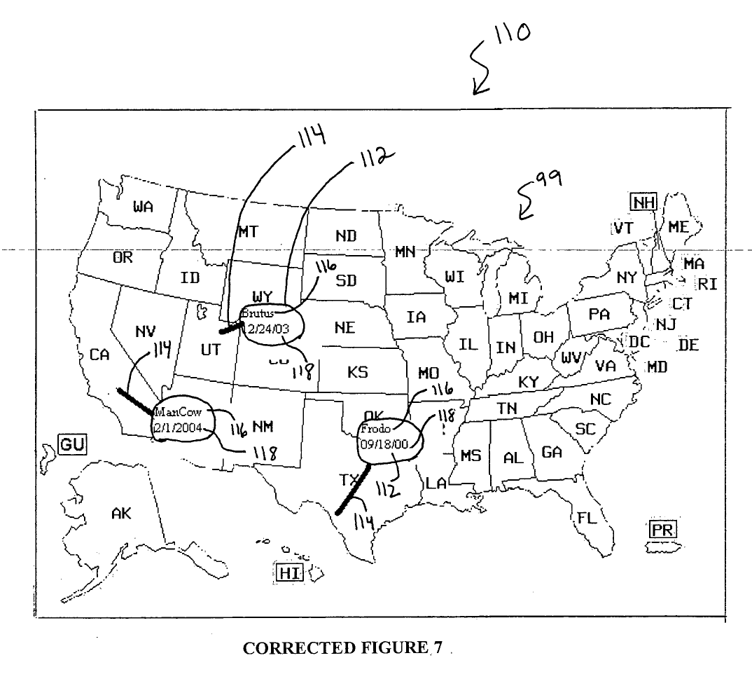

In FIG. 7 is shown yet another embodiment of a container history document 110. In this embodiment, instead of a primarily textual history (as in FIG. 6), this history is shown in terms of geography. Specifically, in this document 110, each user corresponds to an information bubble 112 that includes a pinpointing line 114 showing the location of the user/recipient. The bubble 112 in this embodiment includes the user nickname 116, and the date of receipt 118. However, in other embodiments, a more detailed information bubble 112 could be provided, including all the information as provided in the container registration information forms 26, 82, 95 (FIGS. 2, 4 and 5 respectively). Alternatively, for electronically generated container history documents, the bubble 112 could simply link the user to another page having more textual information regarding the specific user link clicked.

The description of the Figures refers to “container history documents” and “container information registration forms.” It is important to note that, as used herein, “forms” and “documents” are intended to include not only paper forms and documents, but also electronic forms and documents. For example, the container history documents 26, 82, 95, 108, 110 (FIGS. 2, 4, 5, 6 and 7 respectively) could be generated and viewed as a PDF file or an HTML file, or in any other similar format that would be apparent to one skilled in the art.

FIG. 8 is an example of a container history 120 that includes much of the same information requests as already discussed. However, in this embodiment, the launcher could fill out his information 122 and then simply place the document 120 back into the receptacle 22 on the container 10 (FIG. 1). The container, and the accompanying gift, could then be given to a first recipient, who would then fill out the appropriate information 124, and put the document 120 back into the receptacle 22. The first recipient could then give the container 120, along with a gift, to a second recipient, who would then likewise fill out the appropriate information 126. This would continue, similar to the embodiment discussed above, until a final recipient determined to retire the container 120.

One feature of this embodiment is that it does not require the form to be updated with each user/recipient. Rather, any recipient along the chain, including the final recipient, could submit the form 120 to a database manager, who could then enter the information into an online, searchable database. The online database could, as in the previous embodiment, then be searched and viewed by any of the users/recipients.

To illustrate some of the advantages of the present invention, a method of operation is provided below. However, it is noted that the embodiment discussed below is not intended to limit the scope of the present invention, but rather the scope of the invention is considered captured in the appended claims.

In operation, a first user would obtain the reusable gift container 10. There are numerous ways in which the container could be obtained, including, but not limited to, purchasing the container at a gift store, purchasing the container online, or through a catalogue. In FIG. 1, the container is a uniquely shaped box having a unique stripe design 18. However, it is noted that other suitable sorts of containers include, but are not limited to, cloth gift bags, plastic gift boxes, plastic bags, cardboard gift boxes, wood gift boxes, metal containers, paper gift bags, and cloth Christmas stockings.

The launcher would then remove the container history document 24, which, initially, would be a launcher information form 26 (FIG. 2), and would provide the requested information (as shown as handwritten text). The launcher would then submit the filled-in form 26 to a database manager. This submission could be accomplished in a number of ways including, but not limited to, mailing the document 26, e-mailing the information, or through an on-line submission form.

Once the database manager received the information, he or she would enter the information into a database through an information input interface 53. In order to distinguish each container 10 from the others, it is necessary that every container have some sort of unique identifier 20. In this embodiment, the identifier 20 is a serial number assigned at the time of manufacturing/sale. However, the identifier could really be any means whereby the container 10 could be uniquely identified, including, but not limited to, the unique physical attribute 18, the nickname of the launcher, or the container name.

It is noted that, at some point in the container history, the identifier 20 would need to be entered into the database. The identifier 20 is the means whereby the container 10 is distinguished from other containers 10 in the database. For example, in the present embodiment, prior to selling the container 10 to a launcher, the container serial number 20 is entered into the database, along with an image of the container 10. This information can be input through an interface like the one depicted in FIG. 3 (which includes a Container ID input window 54, and an Attach Image button 77).

Once the launcher information of FIG. 2 is entered into the database, the database manager can generate an updated history form 82 (FIG. 4), which includes the launcher's information 84, 86, 83, and return it to the launcher. This document 82 can be returned in any number of ways—e.g. by mail or e-mail—at which time the launcher can place the updated document 82 with the container 10, and then give the container 10, the updated document 82, and a gift, to a first recipient.

Alternatively, once the database manager has entered the launcher's information into the database, because the database is online and searchable, the launcher can access the updated document 82 online and simply print it off. Again, at which time the launcher can place the updated document 82 with the container 10, and then give the container 10, the updated document 82, and a gift, to a first recipient.

The first recipient can then fill in his or her information in the spaces provided 87, 88, 85, 89, 90, and would then submit the filled-in form 82 to a database manager. Again, this submission could be accomplished in a number of ways including, but not limited to, mailing the document 82, e-mailing the information, or through a corresponding on-line submission form.

Once the database manager received the information, he or she would enter the information into a database through an information input interface 53. The database manager could then generate a second updated history form 95 (FIG. 5), which includes the launcher's information 103 and the first recipient's information 101, and return it to the first recipient. As noted above in connection with the updated history form 82 of FIG. 4, this document 95 can be returned in any number of ways—e.g. by mail or e-mail. The first recipient can also, once the database manager has entered the information into the database, access the updated document 95 online and simply print it off, at which time the launcher can place the updated document 82 with the container 10, and then give the container 10, the updated document 95, and a gift, to a second recipient.

This process can be repeated, each time a revised container history being created, until a final user determines to retire the container. Referring to FIG. 5, when it is determined that the container is to be retired, the final recipient would check the “Yes” box 107, provide the date of retirement in space 106, and then submit the information to the database manager. This would constitute a “notice of retirement” as it would put the database manager on notice that the container is to be retired. As with other recipients, the final recipient can also include comments/messages at space 102. These comments could be termed “retirement comments” as they are the last comments made in connection with the particular container 10. The database manager would then input this information into the database through interface 53 (FIG. 3). At this point a final container history document 108 could be created (FIG. 6). The final container history document 108 provides a complete history of the container 10 from launching to retirement. As with the container history documents previously discussed, the final history document 108 can accessed and viewed online, and can include an image of the container. It can also include a geographical history as is depicted in FIG. 7.

It is noted that the user personal information that is provided by the launcher and recipients can include, but is not limited to, user nicknames, user geographical indicators, user messages, gift container purchase date, gift container name, gift description and messages and comments by the users. However, this listing of personal information items is not exhaustive, and could really include any information that may be of interest to those involved in the passing along of the container 10.

### VARIATIONS OF THE PRESENT INVENTION

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope, and numerous modifications and alternative arrangements may be devised by those skilled in the art without departing from the spirit and scope of the present invention.

For example, in one embodiment, the total number of users could be predetermined prior to providing the gift container to the first user or launcher. In other words, prior to launching the container, the determination could be made that it will go to four recipients, and then the fourth recipient is to retire the container. These directives could easily be included in the container history documents.

It is also noted that, in some instances, depending on the durability of the container, retirement of the gift container may never be desired—i.e. the gift container continues to be used in perpetuity.

In yet another embodiment, the launcher and subsequent recipients of the container could add some form of embellishment to the container. For example, the launcher and recipients could each add something to the container such as a sticker, a patch, a button, a mark, design or insignia (e.g. by painting or otherwise). The launcher and subsequent recipients could also include some token or charm with the container that would remain throughout the container's life.

In yet another embodiment, the container and container history could be a means of creating a family history. For example, the user personal information could include information about the launcher's and subsequent recipients' genealogical history, which could then, optionally, be incorporated into the container history document.

In yet another embodiment, the message/comments by the launcher and subsequent recipients could be thematic. For example, the launcher could provide comments on a particular topic such as “My Message to Future Recipients.” This same theme would then be followed by subsequent users/recipients-each giving his or her message to future recipients of the gift container.

In the embodiments above, the online searchable database is discussed in connection with its ability to be searched by past and present users, according to user information (both past and present), as well as the container identifier 20. The database could also be structured such that it is searchable according to other parameters. For example, the database could be searched to generate a report indicating how many different gift containers have been received by a particular user. Other search parameters could include, but are not limited to, how many (and what) different containers have ended up in, or passed through a particular city; how many (and what) different containers have been given outside of the United States; etc. Modification of the database in this manner could be accomplished by one of ordinary skill in the art.

What is claimed is:

1) A method of gift giving, utilizing a reusable gift container, whereby a gift container history is generated including one or more items of past user personal information, comprising the steps of:
a) providing the reusable gift container to a first user, the gift container having:
i) at least one unique physical feature;
ii) a container history document; and
ii) an identifier, whereby the gift container can be distinguished from other gift containers;
b) entering the identifier into a searchable online database through an identifier input interface;
c) directing the first user to update the container history document by providing the identifier and one or more items of first user personal information to a database manager, the one or more items of personal information selected from the group consisting of: a first user nickname, a first user geographical indicator, a first user message, a gift container purchase date, a gift container name, and a first user gift description;
d) directing the database manager to input the one or more items of first user personal information into the searchable online database according to the identifier, and to provide the first user with the container history document including the one or more items of first user personal information;
e) directing the first user to convey the gift container, the container history document, and a first gift, to a second user;
f) directing the second user to update the container history document by providing the identifier and one or more items of second user personal information to the database manager, the one or more items of second user personal information selected from the group consisting of: a second user nickname, a second user geographical indicator, a second user message, the gift container name, and a second user gift description;
g) directing the database manager to input the one or more items of second user personal information into the searchable online database according to the identifier, and to provide the second user with the container history document including the one or more items of first and second user personal information;
h) optionally, directing the second user to convey the gift container, the container history document, and a second gift, to a third user;
i) directing the third user to update the container history document by providing the identifier and one or more items of third user personal information to the database manager, the one or more items of third user personal information selected from the group consisting of: a third user nickname, a third user geographical indicator, a third user message, the gift container name, and a third user gift description;
j) directing the database manager to input the one or more items of third user personal information into the searchable online database according to the identifier, and to provide the third user with the container history document including the one or more items of first, second and third user personal information;
k) optionally, directing the third user to convey the gift container, the container history document, and a third gift, to a fourth user;
l) optionally, repeating steps “i)” through “k)” until retirement of the gift container is desired by a final user;
m) directing the final user to notify the database manager that the gift container is to be retired by providing one or more items of retirement information, selected from the group consisting of: a notice of retirement, a gift container retirement date, and a retirement message;
n) directing the database manager to retire the gift container; and wherein the container history document, as updated by the first user through the final user, provides a gift container history including one or more items of past user personal information.

2) The method of claim 1, wherein the total number of users is predetermined prior to providing the gift container to the first user.

3) The method of claim 1, wherein the gift container is an item selected from the group consisting of: cloth gift bags, plastic gift boxes, plastic bags, cardboard gift boxes, wood gift boxes, metal containers, paper gift bags, and cloth Christmas stockings.

4) The method of claim 1, wherein the identifier is a serial number.

5) The method of claim 1, wherein the step of entering the identifier into the searchable online database through an identifier input interface, also includes the step of entering an image of the gift container into the searchable online database, whereby a user searching the searchable online database can view the gift container history as well as the image of the gift container.

6) The method of claim 1, wherein the container history document is removably contained in a document receptacle on the reusable gift container.

7) The method of claim 6, wherein the document receptacle is a pocket.

8) A method of gift giving, utilizing a reusable gift container, whereby a gift container history is generated including one or more items of past user personal information, comprising the steps of:
a) providing the reusable gift container to a first user, the gift container having:
i) at least one unique physical feature;
ii) a container history document; and
ii) an identifier, whereby the gift container can be distinguished from other gift containers;
b) entering the identifier into a searchable online database through an identifier input interface;
c) directing the first user to update the container history document by providing the identifier and one or more items of first user personal information to a database manager, the one or more items of personal information selected from the group consisting of: a first user nickname, a first user geographical indicator, a first user message, a gift container purchase date, a gift container name, and a first user gift description;
d) directing the database manager to input the one or more items of first user personal information into the searchable online database according to the identifier, and to provide the first user with the container history document including the one or more items of first user personal information;
e) directing the first user to convey the gift container, the container history document, and a first gift, to a second user;
f) directing the second user to update the container history document by providing the identifier and one or more items of second user personal information to the database manager, the one or more items of second user personal information selected from the group consisting of: a second user nickname, a second user geographical indicator, a second user message, the gift container name, and a second user gift description;
g) directing the database manager to input the one or more items of second user personal information into the searchable online database according to the identifier, and to provide the second user with the container history document including the one or more items of first and second user personal information;
h) optionally, directing the second user to convey the gift container, the container history document, and a second gift, to a third user; and wherein the container history document, as updated by the first, second and, optionally, third users, provides a gift container history including one or more items of past user personal information.

9) The method of claim 8, further comprising the steps of:
a) directing the third user to update the container history document by providing the identifier and one or more items of third user personal information to the database manager, the one or more items of third user personal information selected from the group consisting of: a third user nickname, a third user geographical indicator, a third user message, the gift container name, and a third user gift description;
b) directing the database manager to input the one or more items of third user personal information into the searchable online database according to the identifier, and to provide the third user with the container history document including the one or more items of first, second and third user personal information;
c) optionally, directing the third user to convey the gift container, the container history document, and a third gift, to a fourth user;
d) optionally, repeating steps “a)” through “c)” until retirement of the gift container is desired by a final user;
e) directing the final user to notify the database manager that the gift container is to be retired by providing one or more items of retirement information, selected from the group consisting of: a notice of retirement, a gift container retirement date, and a retirement message;
f) directing the database manager to retire the gift container.

10) The method of claim 9, wherein the total number of users is predetermined prior to providing the gift container to the first user.

11) The method of claim 8, wherein the gift container is an item selected from the group consisting of: cloth gift bags, plastic gift boxes, cardboard gift boxes, wood gift boxes, and cloth Christmas stockings.

12) The method of claim 8, wherein the identifier is a serial number.

13) The method of claim 8, wherein the step of entering the identifier into the searchable online database through an identifier input interface, also includes the step of entering an image of the gift container into the searchable online database, whereby a user searching the searchable online database can view the gift container history as well as the image of the gift container.

14) The method of claim 8, wherein the container history document is removably contained in a document receptacle on the reusable gift container.

15) The method of claim 14, wherein the document receptacle is a pocket.

16) A method of gift giving, utilizing a reusable gift container, whereby a gift container history is generated including one or more items of past user personal information, comprising the steps of
a) providing the reusable gift container to a first user, the gift container having:
i) at least one unique physical feature;
ii) a container history document; and
ii) an identifier, whereby the gift container can be distinguished from other gift containers;
b) entering the identifier into a searchable online database through an identifier input interface;
c) directing the first user to update the container history document with one or more items of user personal information, the one or more items of user personal information selected from the group consisting of: a user nickname, a user geographical indicator, a user message, a gift container purchase date, a gift container name, and a user gift description;
d) directing the first user to convey the gift container, the container history document, and a first gift, to a second user;
e) directing the second user to update the container history document with one or more items of user personal information;
f) optionally, directing the second user to convey the gift container, the container history document, and a second gift, to a third user;
g) optionally, repeating steps “e)” and “f)” until retirement of the gift container is desired by a final user;
h) directing one or more of the plurality of users to provide the identifier and the one or more items of personal information to a database manager;
i) directing the database manager to input the one or more items of personal information into the online searchable database through a personal information input interface;
j) directing the final user to notify the database manager that the gift container is to be retired by providing the database manager with one or more items of retirement information, selected from the group consisting of: a notice of retirement, a gift container retirement date, and a retirement message;
k) directing the database manager to retire the gift container; and wherein the container history document, as updated by the first user through the final user, provides a gift container history including one or more items of past user personal information.

17) The method of claim 16, wherein the total number of users is predetermined prior to providing the gift container to the first user.

18) The method of claim 16, wherein the gift container is an item selected from the group consisting of: cloth gift bags, plastic gift boxes, cardboard gift boxes, wood gift boxes, and cloth Christmas stockings.

19) The method of claim 16, wherein the identifier is a serial number.

20) The method of claim 16, wherein the step of entering the identifier into the searchable online database through an identifier input interface, also includes the step of entering an image of the gift container into the searchable online database, whereby a user searching the searchable online database can view the gift container history as well as the image of the gift container.
